(19) United States
(12) Patent Application Publication
(10) Pub. No.: US 2025/0125669 A1
(43) Pub. Date: Apr. 17, 2025

(54) ELECTRIC MOTOR AND HANDWHEEL ACTUATOR ASSEMBLY INCORPORATING A MOTOR

(71) Applicant: ZF Automotive UK Limited, Solihull (GB)

(72) Inventor: Christos Prevezianos, Birmingham (GB)

(21) Appl. No.: 18/911,715

(22) Filed: Oct. 10, 2024

(30) Foreign Application Priority Data
Oct. 12, 2023 (GR) 20230100840

(51) Int. Cl. H02K 1/14; B62D 5/04; H02K 1/04

(52) U.S. Cl. CPC H02K 1/146; B62D 5/046; H02K 1/04; H02K 2201/03

(57) ABSTRACT

An electric motor used in a steering assembly of a vehicle includes a stator and a rotor. The stator carries a plurality of phase windings. The rotor carries a plurality of magnet poles and is connected to a shaft. The stator includes a yoke having a plurality of teeth. Each tooth has a stem and a tooth tip that is located at the end of the stem closest to the rotor. A sleeve of electrically conductive material is located in what is otherwise an airgap between the inwardly facing tips of the stator teeth and the rotor. The sleeve has an electrically conductive material that provides a flux path that extends axially along the motor bore so that rotation of the rotor generates eddy currents within the sleeve that resist rotor rotation.

### TECHNICAL FIELD

This invention relates to electric motors in particular those suitable for use in a handwheel actuator assembly for use in a steer by wire system of a vehicle.

### BACKGROUND

Electric motors are widely used and are increasingly common in automotive applications. For example, it is known to provide an electrically power assisted steering system in which an electric motor apparatus applies an assistance torque to a part of a steering system to make it easier for the driver to turn the wheels of the vehicle. The magnitude of the assistance torque is determined according to a control algorithm which receives as an input one or more parameters such as the torque applied to the steering column by the driver turning the wheel, the vehicle speed and so on.

Another example of use of electric motors in automotive applications is in steer-by-wire systems. During normal use, these systems have no direct mechanical link from the hand wheel that the driver moves and the steered wheels. These systems rely on sensors to relay user input data at a steering wheel to control units which integrate user input data with other information such as vehicle speed and yaw rate, to deliver control signals to a primary motor that physically actuates a steering rack of the vehicle. The control units also act to filter out unwanted feedback from the front wheels and provide a response signal to a secondary electric motor coupled to the steering wheel. The secondary motor provides the driver with the appropriate resistance and feedback in response to specific user inputs at the steering wheel to mimic the feel of a conventional steering system. This secondary motor is connected to a shaft that supports the handwheel through a gearset, and those three parts collectively form a Handwheel Actuator Assembly.

The motors in a steer by wire system are typically constructed with a stator that comprises laminations stacked together in the axial direction. This is both a cost-effective way to manufacture the motors, but also by applying an electrically insulating coating between each lamination in the stack currents are prevented from flowing axially through the stator steel. This reduces energy losses within the motor that would otherwise result from current flowing axially in the stator steel. Such a prior art motor construction exhibits a low level of drag torque from the elimination, or severe restriction, of the current that flows axially.

The term drag torque as used in this description means a torque that is generated by the motor when it is rotating that opposes any torque that is applied to drive the motor. The rotor of a motor which has all of the stator winding phases open-circuited with virtually zero drag torque can be spun with only a small amount of external torque applied, one with a very high drag torque will require an equally high or higher external torque to make the rotor rotate.

In a steer-by-wire system, a malfunction or failure of a portion of the assembly may impair the ability to steer the vehicle. As a result, it is desirable to provide the assembly with structure for providing at least temporary fail-safe operation. US 2006/0042858 A1 discloses steering apparatus including a steering assembly that includes a handwheel actuator. The handwheel actuator includes a steering column for supporting a steering wheel, a gear mechanism and two motors, each for providing a torque to the steering column. Single motor handwheel actuator assemblies are also known.

When the steer by wire system is powered up and functioning correctly, the HWA imposes torque on the shaft carrying the handwheel that in most use cases resists the driver turning the steering wheel shaft. For much of the operation of the system, the motor or motors within the handwheel actuator operate as a controlled resistance to the driver. This can be used to give the driver a feel for what is happening at the interface between the road wheels and the road surface that has otherwise been lost with the removal of the mechanical link from the handwheel to the road wheels.

It is undesirable for the hand wheel to be able to rotate freely and a small amount of resistance to movement, which the driver can always overcome is always desirable. Preferably, this resistance to motion is either constant or proportional to the handwheel speed to enable a good steer-feel. In the prior art it is known to provide resistance to movement by absorbing energy within the motor drive electronics using a principle known as braking torque. For example, see the disclosure of Hendershot & Miller ISBN 978-0-9840687-0-8, page 507 where they talk about braking torque in a line start PM motor arising from current flowing through an external short circuit A braking torque is created when there is at least one closed circuit through the motor phases in which current generated as the motor rotates will flow. This requires active control of the motor drive circuit to operate-typically close-appropriate phase switches and force the closed circuit in the motor.

The applicants have appreciated that it is desirable that this resistance should be present even if the electrical power is removed from the system. Where the resistance is achieved by application of appropriate currents to the motor, this resistance will be removed in the event of a fault where currents cannot be supplied or generated within the motor. The applicants have also appreciated that it is desirable to have minimum electrical connections to the motor and to avoid the use of auxiliary windings and connected controllers to create the resistance to motion in the event of a fault within the system.

### SUMMARY

An object of the present invention is to provide a motor and a handwheel actuator assembly incorporating such a motor that provides a desirable level of resistance to rotation when the motor is not powered.

According to a first aspect the invention provides an electric motor used in a steering assembly of a vehicle, the motor comprising a stator and a rotor, the stator carrying a plurality of phase windings and the rotor carrying a plurality of magnet poles and being connected to a shaft; and in which the stator comprises a yoke having a plurality of teeth, each tooth comprising a stem and a tooth tip that is located at the end of the stem closest to the rotor, and further comprising a sleeve of electrically conductive material that is located in what is otherwise an airgap between the inwardly facing tips of the stator teeth and the rotor, and in which the sleeve comprises an electrically conductive material that provides a flux path that extends axially along the motor bore so that rotation of the rotor generates eddy currents within the sleeve that resist rotor rotation.

The sleeve may optionally be magnetically permeable such that it generates hysteresis loss which can complement the eddy current loss. The eddy currents generate a resisting torque that is proportional to speed while the hysteresis would generate a constant resisting torque. Complementary hysteresis loss would then be beneficial to increase resistance at low speeds.

The motor(s) of the invention generates a desirable level of eddy current and hysteresis loss when the rotor is being turned without the motor being under electrical power and therefore offers a relatively high resistance to rotation, achieved from a sleeve of electrically conductive material in the airgap between the stator and the rotor. The use of a simple sleeve of conductive material provides a design that is well suited to high volume manufacture of electric motors.

The steering assembly may comprise a handwheel actuator of a steer by wire steering system.

The invention incorporates into the motor a conductive part fitted in the inside of the stator bore within the magnetic airgap of the machine. In permanent magnet machines, the flux reversals the conductive part will be subjected to will generate eddy currents, which will generate losses, which in turn will generate a resisting torque working against anything that would rotate the motor shaft.

The conductive sleeve may comprise a solid walled tubular sleeve that is fitted in the airgap between the rotor and the stator.

The rotor may be located concentrically within the stator, each sharing a common axis.

The sleeve may have an inner circumferential wall having a uniform radius at all points and the outer circumferential wall may also have a constant radius such that the sleeve has a uniform thickness as all points.

In an alternative, the thickness of the sleeve may vary around the circumference of the sleeve to define geometric features such as ribs or grooves on the inner and or outer circumferential surfaces.

The outer surface of the sleeve may include a plurality of ribs, each rib extending radially outward into a space between adjacent tips of the stator teeth.

The inner diameter/bore of the stator sleeve need not be entirely round, but may feature protrusions, recesses, flat parts, radii, chamfers or any other distinct geometry that may aid in keeping the flux density as sinusoidal as possible in order to reduce the ripple component of the damping torque or the torque ripple of the machine during regular operation.

In addition to geometric shaping, part or all of the sleeve may be made of magnetically permeable material. Apart from contributing to hysteresis loss as per above, a carefully chosen shape, permeability and saturation flux density can help achieve the optimal flux density to reduce the torque ripple or cogging torque of the motor without significantly affecting torque capability. The material can be chosen to have a permeability and saturation flux density that best serves the application.

The relative permeability could be as low as 18 for some soft magnetic composites or as high as 4000 for electrical steel. The saturation flux density can vary from 0.9 T to more than 1.5 T.

The height of the sleeve measure in the axial direction of the motor may be substantially the same as the height of the stator. As such it may extend from one end of the stator to the other. It may be shorter or longer than this relative to the stator.

The sleeve may include a plurality of cuts out that extend from the inner circumferential wall of the sleeve to the outer circumferential wall whereby strips of material are defined between the cut outs that provide the axially conductive paths. These cut outs may permit air to flow from one side of the sleeve to the other which may be helpful for cooling of the motor.

The sleeve may have generally round inner and outer surfaces, whose outer surface matches the inner diameter of the stator steel. The sleeve may be an interference fit within the airgap contacting the stator teeth. It may be fixed in place using an electrically conductive adhesive between the tips of the teeth and the outer surface of the sleeve.

The stator may be coated in a lacquer that may help adhesion. The sleeve may or may not be tin plated or otherwise passivated to prevent galvanic corrosion if the sleeve material is too far apart in the metal nobility order compared to the stator electrical steel.

The stator sleeve may be located within an airgap that has a length, measured radially from the centre of rotation, that can range from low values of 0.4 mm to larger ones such as 1.5 mm. The airgap length need not be restricted to this range and shall be defined by the electromagnetic performance requirements of the machine, the chosen sleeve material's resistivity, the target damping torque and other performance aspects.

The sleeve may have a length, again measured radially, of between 0.2 mm and 0.6 mm. The radial length need not be restricted to this range, depending on required performance. It may have a length equal to between 20 percent and 50 percent of the airgap.

The sleeve may comprise a metal or metal alloy and may be homogeneous. For example, it may be cast, or pressed or rolled from a uniform stock material. The sleeve material may be different to the stator tooth material.

The sleeve may comprise a copper sleeve or may comprise an aluminium sleeve, or any other conductive material that provides the properties required by the application or to facilitate manufacturing or to reduce costs. For example, because the objective is to maximize braking torque, the highest possible conductivity is beneficial, making copper the most useful option per unit of mass and cost, but aluminium alloys can be useful to reduce cost further or to prevent galvanic corrosion that may otherwise occur.

The lower the resistance the stator sleeve has the higher the losses and therefore the higher the resistance torque felt when the shaft is rotated.

The sleeve may typically have a resistivity of less than 5e−8 Ωm.

The sleeve may have a resistivity of about 3.8e−8 Ωm when made of aluminium alloys or when made of copper has a resistivity of 1.724e−8 Ωm. Any alloyed material that provides the requisite galvanic or mechanical properties that could prevent corrosion and enhance manufacturability may have resistivities that deviate from these values. The sleeve radial length or thickness can then be increased or reduced accordingly to achieve the desired amount of braking torque.

The motor stator may be configured such that the motor stator assembly excluding copper windings has an effective loss per mass of at least 50 Watts per kg of EM-active motor material at a rotational speed of 1000 rpm.

The sleeve may provide the primary source of drag of the motor, although it may be combined with other features that provide a controlled amount of drag.

The stator teeth may comprise stacked laminations of steel plate.

The motor may be configured to provide at least 60 percent of the resistance to rotation of the rotor at least one speed in the range, or at least 70 percent, or 80 percent, or substantially all of the drag torque over a range of non-zero rotational speeds. The motor may provide all or substantially all of the resistance to rotation of the output shaft, by which we mean at least an order of magnitude larger than any resistance provided by mechanical friction present in the motor. The resistance to rotation would typically be amplified by the gearset.

The motor may be configured to provide at least 2 Nm of drag torque over a substantial range of non-zero rotational speeds of the output shaft taking account of gearing between the motor and the output shaft where provided.

The drag torque of the motor may provide at least 60 percent, or at least 70 percent or higher of the resistance to rotation of the shaft at 180 degrees/second speed of rotation of the shaft. It may provide all or substantially all of the resistance to rotation of the shaft, by which we mean at least an order of magnitude larger than any resistance provided by mechanical friction present.

In accordance with a second aspect of the present invention, there is a handwheel actuator assembly of a steer by wire vehicle comprising:
a housing;
a shaft rotatably mounted with respect to the housing;
one or more motors each having a stator and a rotor, the stator carrying a plurality of phase windings and the rotor carrying a plurality of magnet poles and being connected to the shaft;
a control circuit adapted to control the current flowing into or out of the or each motor to cause a net torque to be applied to the shaft during normal operation, and
in which at least one of the motors comprises a yoke having a plurality of teeth, each tooth comprising a stem and a tooth tip that is located at the end of the stem closest to the rotor, and further comprising a sleeve of electrically conductive material that is located in what is otherwise an airgap between the tips of the stator teeth and the rotor, and in which the sleeve comprises an electrically conductive material that provides a flux path that extends axially along the motor bore so that rotation of the rotor generates eddy currents within the sleeve that resist rotor rotation.

The mechanical assembly may include a gearbox comprising a first gear fixed relative to the shaft and a second gear fixed relative to the output of the motor, rotation of the first gear causing a rotation of the second gear.

The two gears may be directly meshed or may be connected to each other through a belt. Where the mechanism is part of a handwheel actuator assembly, the handwheel actuator may comprise a second gear connected to and configured to rotate with the shaft; and a second motor having an output driving a respective second output gear, the second output gear being engaged with the first gear and hence the shaft.

This second motor may also generate a significant drag torque such that the sum of the drag torque from both motors provides a substantially resistance to the turning of the handwheel when the motor is unpowered.

Alternatively, the second motor may have a more conventional construction using electrical steel as the rotor so that it does not play a significant role in the overall resistance to rotation when unpowered. The first motor may therefore provide considerably more drag torque compared to the second for instance at least double the drag torque.

The motor may comprise a brushless permanent magnet type motor comprising a rotor and a stator having many windings surrounding regularly circumferentially spaced teeth.

The shaft may be connectable to a handwheel directly through a splined connector on an end of the shaft fitting in an internally splined connector of the handwheel. The shaft will therefore rotate at the same speed as the handwheel. The motors if directly connected to the shaft will also rotate at the same speed. If the motors are connected to the shaft through a gearbox, they will rotate at a different speed to the handwheel.

Alternatively, the shaft may be connected to the handwheel through a gearbox. In this case the rotational speed of the shaft may differ from the rotation speed of the handwheel.

The motor may form a part of a handwheel actuator assembly of a steer by wire vehicle in which the motor rotor is connected to a shaft that in turn is connected to a handwheel of the vehicle and the handwheel actuator assembly is configured such that in the event that the control circuit is powered down or disconnected and the handwheel is rotated at 180 degrees per second the combination of motors overall provides a drag torque of at least 50 percent of the resistance to rotation of the shaft and a torque at the handwheel of at least 3 Nm.

The handwheel actuator assembly may comprise two of the motors of the first aspect of the invention, the rotor of each motor being connected to the shaft that in turn is connected to the handwheel.

By providing one or more motors where at least one provides a significant and useful level of drag torque, the driver must apply at least 3 Nm at a handwheel speed of 180 degree/second to maintain a constant speed of rotation of 180 degree/second of the handwheel as that resistance must be overcome before any extra torque is used to accelerate the handwheel. This level of resistance is generally considered acceptable in an automotive handwheel actuator application. If it is too low the steering feels too light and may be too easy to turn at high speeds comprising stability, but if too high it may make the steering so heavy the driver may struggle to turn the wheel and manoeuvre the vehicle. When in electrical contact with the stator laminations, the function of the conducting metal coating is to improve conductivity between adjacent laminations such that it approximates the electrical conductivity of a solid magnetic component, such as a stator stack, thereby promoting larger eddy-currents than would normally be the case with insulated laminations in a stack.

The invention provides a damping of an otherwise uncontrolled rotation without electronics, additional mechanical components or complexity that prevents the steering wheel rotating freely when the power is removed, motor disconnected, or under certain fault conditions that render the control unit electrically inoperative. Removing the need to lose energy in the drive circuit, as is known from the prior art, protects the circuit from damage due to heat build-up and moves the heat loss into the motor where it can better be managed.

According to a third aspect the invention provides a method of assembling a motor having the features of the first aspect of the invention comprising inserting the sleeve inside of the stator using a a cold-drop process in which the sleeve is cooled down to an appropriately low temperature where it has contracted such that its outer diameter is small enough to be able to loosely slide into the stator bore and subsequently allowing the sleeve to heat up back to room temperature at which point it will expand to achieve an interference fit with the stator.

That is in effect a reversal of the typical hot-drop process where for instance a housing may be heated up and dropped outside the stator steel outer diameter. As the housing cools down, it contracts and eventually achieves an interference fit with the stator outer diameter. Such a process could be used but this is more difficult as the windings and so on around the stator may not be able to cope with the high temperatures required.

### BRIEF DESCRIPTION OF THE DRAWINGS

There will now be described by way of example only one embodiment of the present invention with reference to and as illustrated in the accompanying drawings of which:

FIG. 1 shows the key mechanical components of an embodiment of a handwheel actuator assembly according to an aspect of the invention that includes a pair of motors that may each fall within a further aspect of the invention;

FIG. 2 shows another embodiment of a handwheel actuator assembly according to an aspect of the invention;

FIG. 3 shows a general arrangement of an electronic control unit which controls the two motors of a dual motor drive assembly according to a first aspect of the invention;

FIG. 4 shows a layout of a Steer-by-Wire system including a dual motor drive assembly according to a first aspect of the invention;

FIG. 5 shows in cross section the configuration of a motor that may be used in the mechanism of FIG. 1; and

FIGS. 6 shows the eddy current density of a simple sleeve within the motor of FIG. 5 when the rotor is turned whilst the motor is isolated from a supply of electrical power.

### DESCRIPTION

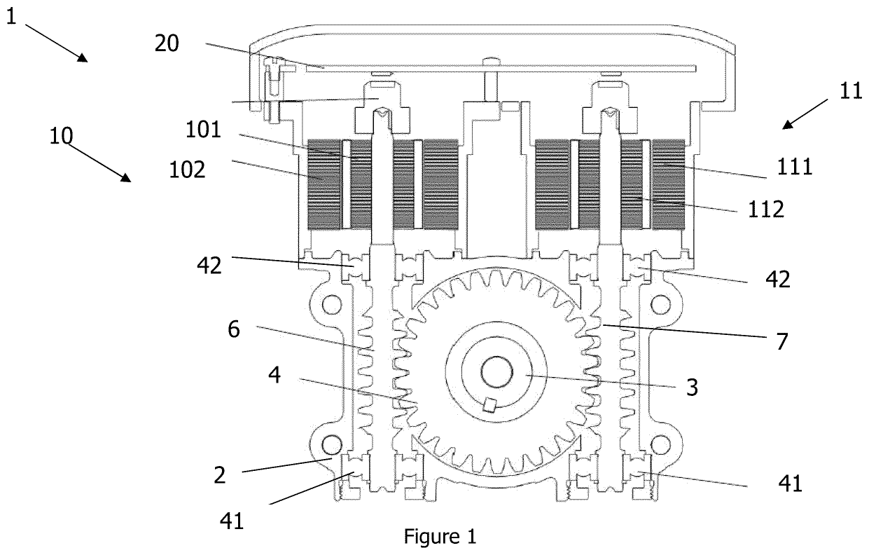

FIG. 1 shows a handwheel actuator (HWA) assembly of a vehicle, according to a first aspect of the invention. This example is a dual motor assembly which has two motors, each connected to a common shaft through a respective gearbox. The invention can be implemented with a single motor and also without the presence of a gearbox by direct connection of the motor rotor to the shaft. The motors have special properties and embody the first aspect of this invention and examples of the motor construction are presented in FIGS. 8 to 11. By describing the motors in relation to one potential use in a handwheel actuator assembly the benefits of these motors over conventional motors in such applications can be readily understood.

The assembly 1 includes a first motor 10 with rotor 101 and stator 102 and a second motor 11 with rotor 111 and stator 112, the first motor 10 being connected to a first worm gear 6 and the second motor 11 being connected to a second worm gear 7.

Each worm gear 6, 7 comprises a threaded shaft arranged to engage with a gear wheel 4 connected to a steering column shaft 3 such that torque may be transferred from the worm gears 6, 7 to the gear wheel 4 connected to the steering column shaft 3. The gear wheel 4 is operatively connected to a driver's handwheel (not shown) via the steering column shaft 3. In this example, each of the two motors 10, 11 are brushless permanent magnet type motors and each comprise a rotor 101, 111 and a stator 102, 112 having many windings surrounding regularly circumferentially spaced teeth. The arrangement of the two motors 10, 11, the shaft 3, the worm gears 6, 7 and the wheel gear 4 together form a dual motor electrical assembly.

Each of the two motors 10, 11 are controlled by an electronic control unit (ECU) 20. The ECU 20 controls the level of current applied to the windings and hence the level of torque that is produced by each motor 10, 11.

In this example, the two motors 10, 11 are of a similar design and produce a similar level of maximum torque. However, it is within the scope of this disclosure to have an asymmetric design in which one motor 10, 11 produces a higher level of torque than the other 10, 11.

One of the functions of a handwheel actuator (HWA) assembly is to provide a feedback force to the driver to give an appropriate steering feel. This may be achieved by controlling the torque of the motors 10, 11 in accordance with signals from the handwheel actuator (such as column angle) and from other systems in the vehicle (such as vehicle speed, rack angle, lateral acceleration and yaw rate).

The use of two motors 10, 11 is beneficial in eliminating rattle. If a single electric motor were instead used in a torque feedback unit, the motor may be held in locked contact with the gearing by means of a spring. However, in certain driving conditions the action of a spring is not sufficiently firm, which allows the gears to “rattle” during sinusoidal motions or sharp position changes of the steering column.

Use of two motors 10, 11 which can be actively controlled (as in the present embodiment) ameliorates the problems associated with use of a single motor. In this arrangement, both motors 10, 11 are controlled by the ECU 20 to provide torque feedback to the steering column and to ensure that the worm shafts 6, 7 of both motors 10, 11 are continuously in contact with the gear wheel 4, in order to minimise rattle. The use of two motors 10, 11 in this way also allows active management of the friction and thereby the feedback force to the driver.

As shown in FIG. 1, the motors 10, 11 are received in and secured to a transversely extending two-part extension of a housing 2. The worm shaft 6, 7 of each motor is supported relative to the housing by two sets of bearings. A first set of bearings 41 supports a first end of each worm shaft 6, 7 distal their respective motor 10, 11 while a second set of bearings 42 supports a second end of each worm shaft 6, 7 proximal their respective motor 10, 11.

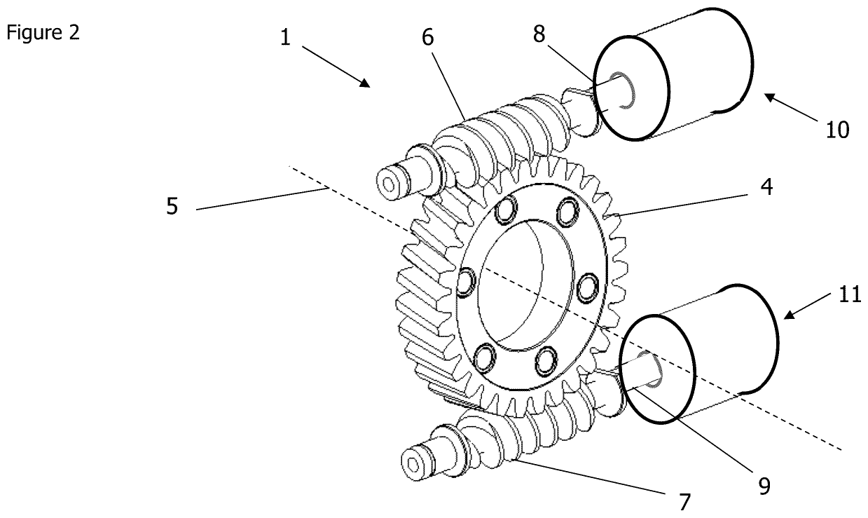

FIG. 2 shows an axis of rotation of the shaft 3 marked using a dashed line 5, extending perpendicularly through the gear wheel 4. The periphery of the gear wheel 4 is formed as a worm gear which meshes with each of two identical worm screws 6, 7 located on opposite sides of the longitudinal axis 5 of the shaft 3. Each worm screw 6, 7 is connected to the output shaft 8, 9 of a respective electric motor 10, 11.

The axes of the output shafts 8, 9 of the two motors 10, 11 are arranged perpendicularly to the rotational axis of the shaft 3 and the axes of the two motors may also be inclined with respect to each other, to reduce the overall size of the assembly.

The motors 10, 11 are controlled by the electronic control unit (ECU) 20 such that at low levels of input torque applied to the shaft 3 by the handwheel, the motors 10, 11 act in opposite directions on the gear wheel 4 to eliminate backlash. At higher levels of input torque applied to the shaft 3 by the handwheel, the motors 10, 11 act in the same direction on the gear wheel 4 to assist in rotation of the shaft 3. Here, a motor 10, 11 acting in ‘a direction’ is used indicate the direction of torque applied by a motor 10, 11 to the gear wheel 4.

The use of two separate motors 10, 11 which can be controlled in a first operational mode to apply torque in opposite directions to the gear wheel 4 eliminates the need to control backlash with precision components. In addition, the use of two separate motors 10, 11 which can be controlled in a second operational mode to apply torque in the same direction to the gear wheel 4 allows the motors 10, 11 and gear components 4, 6, 7 to be specified at half the rating of the required total system torque, thereby reducing the size and cost of the drive assembly 1.

In the embodiment shown in FIGS. 1 and 2, the worm shafts 6, 7 engage diametrically opposed portions of a gear wheel 4. The threads of the worm shafts 6, 7 each have the same sense, i.e., they are both left-handed screw threads. The motors 10, 11 are configured such that they lie on the same side of the gear wheel 4 (both motors 10, 11 lie on one side of a virtual plane perpendicular to axes of the worm shafts 6, 7 and passing through the centre point of the gear wheel 4). Considering as an example the perspective shown in FIG. 2, driving both motors 10, 11 clockwise would apply torque in opposite directions to the gear wheel 4, with motor 10 applying a clockwise torque to gear wheel 4 and motor 11 applying an opposing anti-clockwise torque to gear wheel 4.

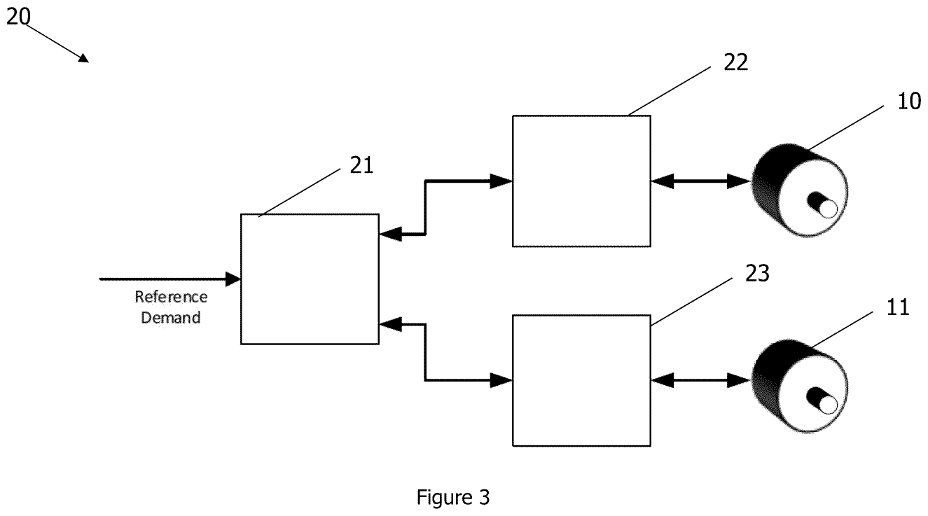

FIG. 2 shows another embodiment of a handwheel actuator assembly 1 according to the first aspect of the invention. This embodiment is substantially similar to the embodiment shown in FIGS. 1 and 2 with the only difference being the positioning of the motors 10, 11. Components and functional units which in terms of function and/or construction are equivalent or identical to those of the preceding embodiment are provided with the same reference signs and are not separately described. The explanations pertaining to FIG. 1 therefore apply in analogous manner to FIG. 3 with the exception of the positioning of the two motors 10, 11.

In FIG. 2 the worm shafts 6, 7 engage diametrically opposed portions of a gear wheel 4 and threads of the worm shafts 6, 7 each have the same sense, i.e., in this example, they are both right-handed screw threads. The motors 10, 11 are configured such that they lie on opposing sides of the gear wheel 4 (motor 10 lies on one side of a virtual plane perpendicular to axes of the worm shafts 6, 7 and passing through the centre point of the gear wheel 4 while motor 11 lies on the other side of this virtual plane).

Application of torque by a driver in a clockwise direction results in rotation of the handwheel 26 and the steering column shaft 3 about the dashed line 5. This rotation is detected by a rotation sensor (not shown). The first motor 10 is then controlled by the ECU 20 to apply torque in the opposite direction. In a first operational mode, the second motor 11 is actuated by the ECU 20 to apply an offset torque 32 in the opposite direction to the torque 30 of the first motor 10 to reduce gear rattling. Alternately, in a second operational mode, the second motor 11 is actuated by the ECU 20 to apply a torque 34 in the same direction to the torque 30 of the first motor 10 to increase the feedback torque to the steering column shaft 3.

The net result of the torques by the first and second motors 10, 11 results in an application of a feedback torque to the steering column shaft 3 and handwheel 26,, to provide a sensation of road feel to the driver. In this example, the application of a feedback torque is in the opposite direction to that applied to the handwheel 26 by the driver. In this way, the “rattle” produced between the worm shafts 6, 7 and the gear wheel 4 can be eliminated or significantly reduced.

FIG. 3 reveals part of an HWA assembly 80 showing a general arrangement of an electronic control unit (ECU) 20 which controls each of the two motors 10, 11. The ECU 20 may include a hand wheel actuator (HWA) control system 21 as well as a first and second motor controller 22, 23 which control the first and second motors 10, 11 respectively. A reference demand signal is input to the HWA control system 21 which allocates torque demands to each of the first and second motors 10, 11. These motor torque demands are converted to motor current demands and transmitted to the first and second motor controllers 22, 23. Each motor 10, 11 provides operating feedback to their respective motor controller 22, 23. The HWA control system 21 is configured to calculate the magnitude of mechanical friction using the motor torque demands. In another embodiment, the HWA control system 21 may be implemented by a separate ECU to the first and second motor controller 22, 23.

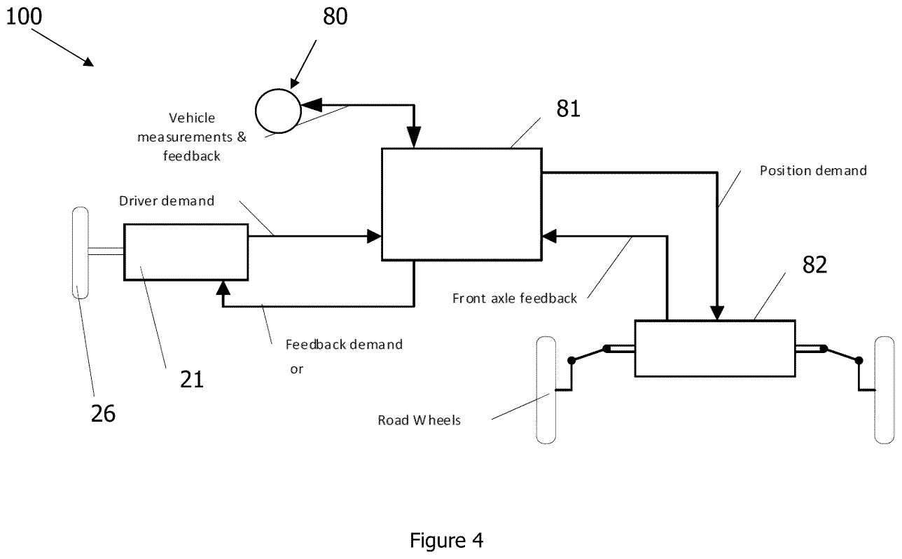

FIG. 4 shows an overall layout of a Steer-by-Wire system 100 for a vehicle including the handwheel actuator (HWA) assembly 80 according to a first aspect of the invention. The HWA assembly 80 supports the driver's handwheel 26 and measures the driver demand which is usually the steering angle. A steering controller 81 converts the driver demand into a position demand that is sent to a front axle actuator (FAA) 82. The FAA 82 controls the steering angle of the roadwheels to achieve the position demand. The FAA 82 can feedback operating states and measurements to the steering controller 81.

The steering controller 81 combines the FAA 82 feedback with other information measured in the vehicle, such as lateral acceleration, to determine a target feedback torque that should be sensed by a driver of the vehicle. This feedback demand is then sent to the HWA control system 21 and is provided by controlling the first and second motors 10, 11 with the first and second motor controllers 22, 23 respectively.

FIG. 4 shows the steering controller 81 as physically separate to both the HWA controller 21 and the FAA 82. Alternately, different architectures, where one or more of these components are physically interconnected, may be used within the scope of this disclosure. For example, the functions of the steering controller 81 may be physically implemented in the HWA controller 21, the FAA 82, or another control unit in the vehicle, or some combination of all 3. Alternatively, control functions ascribed to the HWA controller 21 and FAA 82 may be partially or totally implemented in the steering controller 81.

In the event that there is a fault in the motor windings that prevents any current flowing through the motor, or disconnection of motor from the control electronics, or in the motor drive stage or in the control system, including a loss of electrical power to the handwheel assembly, it becomes impossible to control the rotation of the handwheel by the driver in order to provide feedback. The motors of the handwheel actuator assembly of FIG. 1 are configured in order to ensure that there is some damping of the rotation of the wheel in this condition. This is beneficial as it will feel more natural to the driver and will also help them not make steering inputs at too high a rate by damping their actions.

In a conventional prior art Handwheel actuator assembly the motor is fabricated using a high-performance electrical steel for the stator as it is generally desirable to reduce the level of drag torque and the resulting energy losses. Further reductions are attained by the use of a laminated stator in which electrical steel plates are held apart by interleaved layers of insulating material.

In the embodiment of FIG. 1 and the embodiment of FIG. 2 the two motors are the same and each is configured to provide a substantial level of drag torque when a driver rotates the motor in an unpowered condition by rotating the handwheel. This ensures the handwheel does not spin freely in the event of a fault that removes power from the motor or where the motor has an internal fault that means the current in the windings does not generate any motoring torque in the motor. An added benefit is that more energy is consumed within the motor compared with a low drag torque motor and so there is less for the electronics to do to provide a controlled resistance, heat being dissipated within the motor rather than from the electronics.

The skilled person will understand that the invention can be implemented with only one of the motors providing a substantial drag torque and the other a conventional motor used in prior art handwheel actuators with a low drag torque.

By drag torque we mean the torque arises due to energy conversion within the stator of the motor as it is rotating. Mechanical energy from the driver causes the rotor to rotate. As it rotates the rotor and stator interact magnetically generating a changing flux within the stator. This will give rise to both eddy currents and hysteresis losses and electrical energy is converted to heat as these currents pass through the resistive material forming the stator. Thus, mechanical energy is converted heat and a drag torque results.

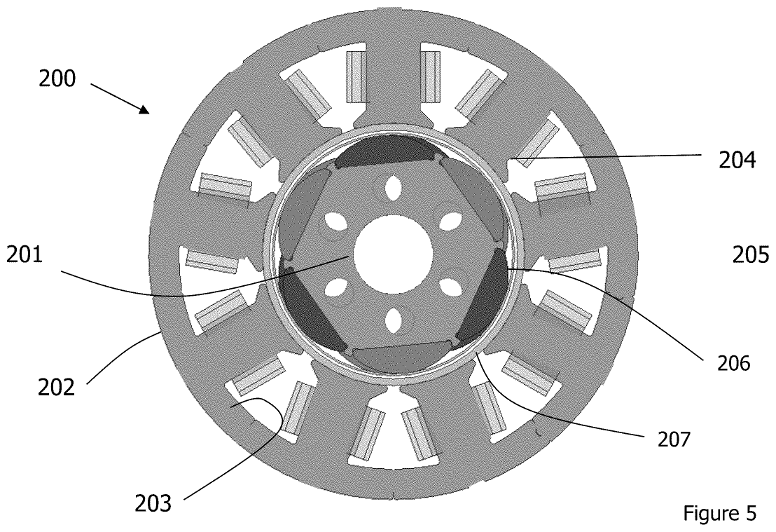

A first construction of a motor 200 which can be used as one or both of the motors 1,11 of FIG. 1 and FIG. 2 is shown in plan view in FIG. 5. The motor 200 comprises a rotor 202 and a stator 201. The stator 201 comprises a circular yoke body 203 and has a set of teeth 204 which each project radially away from the yoke body 203. The ends of the teeth furthest from the yoke body 203 are widended to form arcuate tips 205. These tips and the rotor 202 together form an airgap.

The yoke body may be one continuous tube as shown or more likely may comprise a set of arcuate sections each of which supports two or more of the teeth. Windings) of electrical wire are wrapped around the teeth between the outer yoke body 202 and the teeth tips, and these are connected together to form a set of motor phases, for example into three separate phases. Each phase can then be supplied with a current from a motor drive circuit, the modulation of the currents controlling the movement of the motor.

Each tooth 204 extends axially down the stator from an upper end to a lower end. The rotor 202 fits within the void defined by the tips of these teeth 203 and has an axis that is common with the axis of the stator yoke. The rotor carries a set of permanent magnets 206.

The stator 201 in this example comprises a stack of laminations in the form of metal plates that may be stamped or otherwise cut out of a large metal sheet. An insulating coating may be provided on the surface of each lamination to help prevent corrosion of the metal plates.

The stator teeth 204 and rotor 202 define an airgap. In this example the airgap is around 1.2 mm. A sleeve 207 of electrically conductive material is located in this air gap that has a length of around 0.4 mm. This has an outer surface that abuts the tips of the teeth and as such takes up a third of the airgap leaving a true airgap remaining of 0.8 mm.

The sleeve 207 in this example is a copper tube having perfectly cylindrical inner and outer bores. In a modification, the sleeve may be provided with an assortment of grooves or ribs on either the inner bore or outer bore or both which extend axially along the sleeve. Where outer ribs are provided these may extend into the circumferential spaces between adjacent teeth 204.

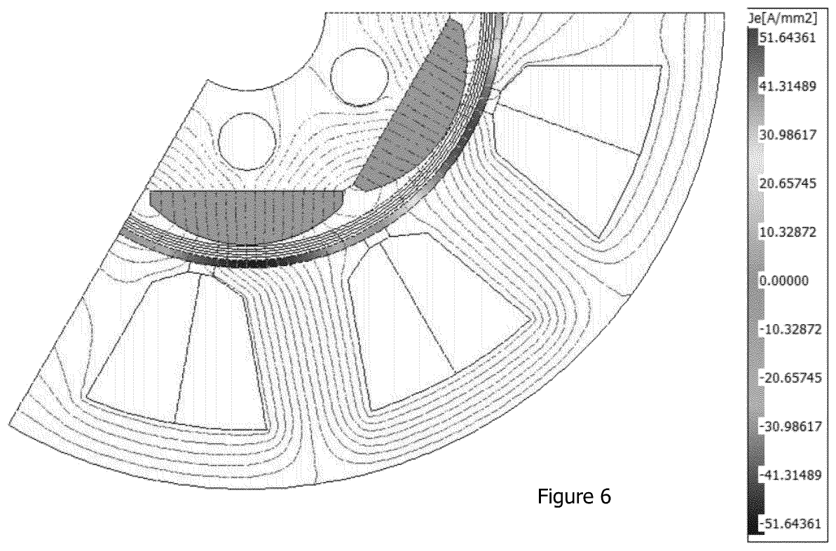

FIG. 6 illustrates how Eddy currents are formed in the sleeve due to it having a low electrical resistance and relatively large thickness compared to the length of the airgap. These Eddy currents provide resistance to rotation of the rotor, helping damp the motor movement in the event of a loss of power. This effect occurs because the sleeve will be stationary as the rotor rotates and will therefore be subjected to flux reversals as north and south magnet poles pass radially “underneath” it even when the machine is unpowered. Due to said flux reversals, if this tube is made of conductive material, eddy currents and therefore heat loss will be generated. This will be felt as damping torque to the force rotating the rotor shaft. With carefully chosen (generally high) conductivity, thickness and other geometry features, the machine can be designed to match specific levels of damping torque.

1. An electric motor used in a steering assembly of a vehicle, the motor comprising a stator and a rotor, the stator carrying a plurality of phase windings and the rotor carrying a plurality of magnet poles and being connected to a shaft; and
in which the stator comprises a yoke having a plurality of teeth, each tooth comprising a stem and a tooth tip that is located at the end of the stem closest to the rotor,
and further comprising a sleeve of electrically conductive material that is located in what is otherwise an airgap between the inwardly facing tips of the stator teeth and the rotor,
and in which the sleeve comprises an electrically conductive material that provides a flux path that extends axially along the motor bore so that rotation of the rotor generates eddy currents within the sleeve that resist rotor rotation.

2. A motor according to claim 1 in which the conductive sleeve comprises a solid walled tubular sleeve that is fitted in the airgap between the rotor and the stator.

3. A motor according to claim 1 in which the sleeve has an inner circumferential wall having a uniform radius at all points and the outer circumferential wall also have a constant radius such that the sleeve has a uniform thickness as all points.

4. A motor according to claim 1 in which the outer surface of the sleeve includes a plurality of ribs, each rib extending radially outward into a space between adjacent tips of the stator teeth.

5. A motor according to claim 1 in which the height of the sleeve measured in the axial direction of the motor is substantially the same as the height of the stator.

6. A motor according to claim 1 in which the radially outer facing surfaces of the sleeve are an interference fit within the airgap with the radially inward facing surfaces of the tips of the teeth.

7. A motor according to claim 1 in which the inner sleeve comprises a magnetically permeable material.

8. A motor according to claim 1 in which the stator is coated in a lacquer where it contacts the sleeve.

9. A motor according to claim 1 in which the sleeve is tin plated or otherwise passivated to prevent galvanic corrosion if the sleeve material is too far apart in the metal nobility order compared to the stator material.

10. A motor according to claim 1 in which the sleeve comprises a metal or metal alloy.

11. A motor according to claim 9 in which the sleeve is a copper sleeve.

12. A handwheel actuator assembly of a steer by wire vehicle comprising:
a housing;
a shaft rotatably mounted with respect to the housing;
one or more motors each having a stator and a rotor, the stator carrying a plurality of phase windings and the rotor carrying a plurality of magnet poles and being connected to the shaft;
a control circuit adapted to control the current flowing into or out of the or each motor to cause a net torque to be applied to the shaft during normal operation, and
in which at least one of the motors comprises a yoke having a plurality of teeth, each tooth comprising a stem and a tooth tip that is located at the end of the stem closest to the rotor,
and further comprising a sleeve of electrically conductive material that is located in what is otherwise an airgap between the tips of the stator teeth and the rotor, and in which the sleeve comprises an electrically conductive material that provides a flux path that extends axially along the motor bore so that rotation of the rotor generates eddy currents within the sleeve that resist rotor rotation.
